(19) United States
(12) Patent Application Publication
(10) Pub. No.: US 2012/0074679 A1
(43) Pub. Date: Mar. 29, 2012

(54) Multipurpose tarpaulin sled apparatus

(76) Inventor: Ronnie G. Kinsey, Frisco City, AL (US)

(21) Appl. No.: 11/708,320

(22) Filed: Feb. 16, 2007

(51) Int. Cl. B62B 15/00

(52) U.S. Cl. 280/845

(57) ABSTRACT

Apparatus for hauling or moving material or debris associated with landscaping, lawn care, outdoor recreation, or other similar items in which a flat tarpaulin type surface is used to easily receive such debris, such as bulk leaves or grass clippings, weeds, hand tools, or other generally lightweight services so that they may be easily pulled about a lawn or field or other similar area and discarded. The apparatus is designed for use with a variety of power sources and can be further adapted to secure a load upon the surface. The apparatus is designed for easy care and maintenance and storage and for simplicity of use.

The invention relates to apparatus useful in hauling a variety of small to large items, particularly those related to the care and maintenance of landscape and outdoor recreational endeavors. In particular, the apparatus is and can be adapted to a variety of items with respect to both size and weight, from lawn refuse to game animals.

### BACKGROUND OF THE INVENTION

A common requirement during the tasks associated with lawn maintenance and landscape functions is the requirement to move a variety of materials and waste product from one place to another. Such could include shrubbery clippings, leaves, tree limb clippings, cut grass, soil, or a variety of other materials and objects, which are involved with these functions.

It is typical that these materials are gathered together in someplace central or near their collection and then transported in wheelbarrows, wagons, baskets, waste cans, or a variety of gathering implements. It can be very time consuming and, in some cases, uncomfortable to accomplish this task, because leaves and grass clippings and shrub clippings don't stay together like we would like them to do when we gather them to place them in a can, and they also frequently contain unpleasant contents, such as thorns, insects, or various substances which may cause itching or blemishing. Accordingly, it would be good to find some means of handling this task, which is both efficient and avoids the need for inordinate personal contact with the waste material.

It is also true that these same kinds of challenges are faced by those who engage in outdoor recreational activities, such as hunting and fishing. These activities normally require movement of implements and supplies across terrain which is not adopted with roads for motor vehicles. This would include equipment and provisions for camping, hunting, and fishing and also may include the requirement for moving fish and game back out of the same terrain. Often these areas can be reached and maneuvered by certain recreational vehicles and other times they may be accessible only by foot.

In the past, there have been several different “sled” type apparatus developed for accomplishing these tasks. In essence, what these apparatus accomplish is the ability to quickly move the target material onto a surface with minimum contact and then drag the material away. This is useful and helpful because it saves both time and reduces the need to personally come in contact with the target material.

Several of these apparatuses are described. It is noted at the outset, that common features of such devices is that they are substantially open and comprise a minimal structure of containment. They are typically little more than a flat and flexible surface. The flatness makes them simple to “load” with waste material because such can easily be raked or pushed onto the flat surface without lifting or gathering. The flexibility usually derives from the fact that the materials are lightweight and easy to manipulate. The drawback of such flatness is that there is little to prevent the waste material from falling off of the surface as the materials are being pulled. A drawback of the flexibility is that, when pulling the flat surface, the leading edge of the surface may often contract or change shape under the force of the pull.

The invention taught by Jones, et al., U.S. Pat. No. 6,565,101, issued on May 20, 2003, demonstrates what is described as a “hauling tarpaulin” for lawn waste. The apparatus comprises a tarpaulin which is said to be stabilized against wind by a rear “mandrel” apparatus which further comprises a series of collapsible “legs” which will elevate the rear end of the tarpaulin when it is pulled. The apparatus is meant to be pulled by a single person by use of a cord which runs through grommets about the diameter of the tarpaulin and which are arranged to cause the sides of the tarpaulin to rise as well as the rear mandrel arrangement. In a series of alternate embodiments the collapsible legs of the rear mandrel arrangement take different shapes and forms. This invention is only suitable for pulling by hand and requires the use of a somewhat complicated mandrel assembly on its rear.

U.S. Pat. No. 4,173,351, issued to Hetland on Nov. 6, 1979, taught a more rigid form of sled in which rigid sides (perhaps of corrugated cardboard) and a floor formed a loose enclosure into which long letter could be placed easily by means of a collapsible front end. The collapsible front end could be easily manipulated into opened and closed positions by means of a hinge powered by the pulling cord. This apparatus, primarily because of its rigidity, cannot be folded or rolled into a compact storage configuration.

U.S. Pat. No. 6,276,698, issued to Calandra on Aug. 20 1, 2001, teaches a sled which is meant for hauling more substantial items, such as game from hunting, by use of a motorized or powered towing vehicle. Because of the weight of the item to be towed the sled requires a substantial frame and hauling surface and it is also necessary to use sled implements to elevate the hauling surface and minimize the friction between the ground and the hauling platform.

In order to demonstrate the variety of implements which have been used to ease this task, reference is also made to U.S. Pat. No. 5,163,278, issued to Martenhoff on Nov. 17, 1992. This invention teaches a lawn waste banking device which is light weight and allows lawn waste to be easily raked into the apparatus by means of an opening flat against the ground when the apparatus is laid on its side and then to be easily carried away. While this apparatus assists and hauling smaller quantities of lawn waste, it requires dead weight lifting of the waste and, because of its rigid corners, is also difficult to fold up and store in a small area.

Each of these apparatuses depend upon the ease of raking or other wise pushing bulk litter, such as leaves are grass clippings, onto flat surfaces on or near the ground. This saves the repetitive tasks of bending over again and again to lift or move small quantities of waste material into a container. Accordingly, each of them are helpful in this regard. The flat surfaces upon which the waste is placed must then be moved, effectively causing them to now be a mobility surface.

Once the target material is loaded on to a mobility surface (such as a tarpaulin), the next task is that of moving the material with the tarpaulin in an efficient manner and with minimum spill or loss of the target material. In order to accomplish these tasks, it would be useful to provide a means of moving the tarpaulin surface without substantially changing its shape and orientation. The prior art, while achieving many of the desired objectives, could be improved if a more reliable, efficient, and simplistic means of transporting a loaded tarpaulin could be provided.

What is not provided in the prior art is such an easy load apparatus for lawn waste, gardening equipment and supplies, recreational equipment, or other similar target material to be moved which affords both the ease of loading the target waste upon the apparatus and also allows larger quantities to be pulled or hauled over greater distances, including the ability to use powered vehicles to assist in this task.

### SUMMARY AND OBJECTS OF THE INVENTION

The inventor has achieved a solution to this problem by developing a novel and effective means of adopting such a tarpaulin to transport from a variety of transporting modes and for hauling a variety of target material. This could include the simple pulling of lawn waste by hand or with a shoulder harness or it could also include the use of a shoulder harness, a riding lawn mower, a tractor, recreational vehicle, or even a winch or other pulling force.

The primary components of the invention include a harnessing mechanism which is adapted to connect the hauling apparatus with a desired source of power, a hauling surface, and means for securing a target load. As will be seen herein, the same general combination of components can be easily adopted for use in a variety of applications.

In the preferred embodiment of the present invention, this has been accomplished by adopting a tarpaulin with means of a shaft or rigid member which may be affixed to the leading edge of the tarpaulin and by further adopting the shaft with means of connection to a pulling force or any one of a variety of pulling forces. In this manner, since the leading edge of the tarpaulin will be stabilized about its length by the shaft, the tarpaulin will maintain its shape as it is pulled or towed by whatever force is desired. The shaft also provides some stability against the forces of the wind. The shaft or the shaft connection means are adopted with adequate means of connection to the pulling force so that the pulling can be done from a single location (such as a hand, trailer hitch, or shoulder harness) and stretched about the entire leading edge of the tarpaulin with stability.

The apparatus may be further enhanced by adaptations to the tarpaulin itself to further minimize loss of the target waste material or to provide additional strength and durability. Such may include names of elevating side members about the diameter of the sled or tarpaulin as it is pulled. It should be recognized, however, that even with light materials such as leaves or grass clippings, the waste material will substantially remain upon the tarpaulin except in extremely dry or windy conditions or if the apparatus is moved too quickly. Moreover, the apparatus may be yet further enhanced by designs, which facilitate deployment, recovery, and storage of the apparatus.

It is, then, an object of the present invention to provide an efficient means of gathering and moving waste or other material during the conduct of lawn and landscape maintenance by providing a reliable transportation mechanism adaptable to a variety of pulling forces.

It is a further object of the present invention to provide such a waste or material moving mechanism, which will maintain its structural integrity as it is loaded and moved with a target waste material.

It is a further object of the present invention to provide such a waste or material moving mechanism, which will also minimize the loss of waste or other material during transportation operations.

It is a further object of the present invention to provide such a waste or material moving mechanism adaptable with such enhancing features, which will also minimize the need for human contact with the waste material.

It is a further object of the present invention to provide such a transportation mechanism, which will further be capable of efficient employment, recovery, and storage.

It is a further object of the present invention to provide such an apparatus which can be easily rolled up for storage in a compact configuration so as to require minimal space within a garage, closet, or other storage facility.

Other features and advantages of the present invention will be apparent from the following description in which the preferred embodiments have been set forth in conjunction with the accompanying drawings.

### BRIEF DESCRIPTION OF THE DRAWINGS

In describing the preferred embodiments of the invention, reference will be made to the series of figures and drawings briefly described below.

FIG. 1 is a depiction of the entire apparatus viewed from above which depicts each of the major components of the preferred embodiment and further depicts their relative positioning.

FIG. 2 depicts the apparatus which has been further adapted with straps useful in securing a load upon the sled and eyelets which may be used to secure the straps.

FIG. 3 depicts the basic embodiment of the invention in a very simple form without enhancing features for added strength or security of the load.

FIG. 4 depicts the manner in which the forward support shaft and sleeve are connected to a desired poll source and further demonstrates how the apparatus may be widened in order to either accommodate a larger load or to support and equalize a load.

FIG. 5 depicts how the tarpaulin can be widened in order to allow either a larger load or to allow the tarpaulin edges to be folded up so as to more securely keep waste material confined upon the tarpaulin surface.

FIG. 6 depicts how the widened the tarpaulin could be coupled with a widened or extended forward support shaft in order to provide a larger tarpaulin surface.

FIG. 7 depicts the apparatus as it may be folded up for storage.

While certain drawings have been provided in order to teach the principles and operation of the present invention, it should be understood that, in the detailed description, which follows, reference may be made to components or apparatus which are not included in the drawings. Such components and apparatus should be considered as part of the description, even if not included in such a drawing. Likewise, the drawings may include an element, structure, or mechanism which is not described in the textual description of the invention which follows. The invention and description should also be understood to include such a mechanism, component, or element which is depicted in the drawing but not specifically described.

### DETAILED DESCRIPTION OF THE PREFERRED EMBODIMENT

Reference will now be made in detail to the present preferred embodiment of the invention, an example of which is illustrated in the accompanying drawings. While the invention will be described in connection with a preferred embodiment, it will be understood that it is not intended to limit the invention to that embodiment. On the contrary, it is intended to cover all alternatives, modifications, and equivalents as may be included within the spirit and scope of the invention defined in the appended claims.

While the following description will seek to improve understanding of the invention by describing the various components and elements, it should be considered that certain apparatus may be sufficiently and adequately explained by the accompanying drawings, which are fully incorporated herein, and not require further description. All such apparatus should be considered as part of the specification of the invention for all purposes.

Making reference to each of the first six figures it can be seen that they all have three basic elements in common. First, they each have a pulling assembly (10), a forward mounting member (30) which provides both a means of stable connection with the pulling assembly (10), and a sled member (50). These essential elements of the apparatus are necessary to provide the functions of connection to a power source, stabilization of the load carrying component, and the load carrying component itself. Each of the embodiments and alternatives will have these elements, which form the essence of the invention.

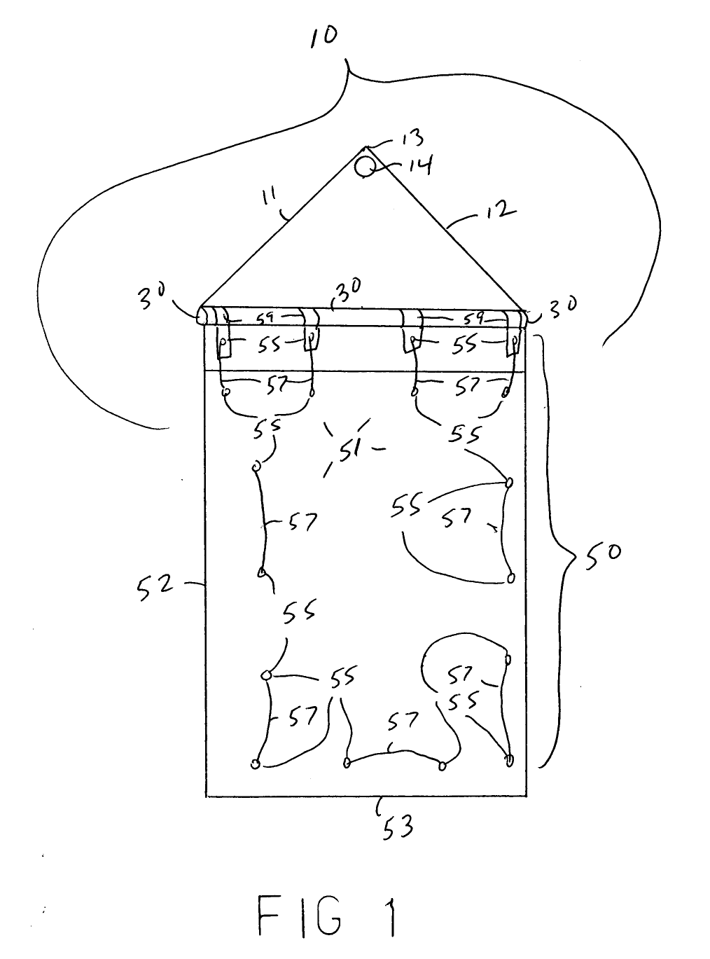

FIG. 1 depicts the most fundamental form of the apparatus. The pulling assembly (10) is shown as the legs (11, 12) of the triangle formed by said legs (11, 12) and the forward support member (30). It is directly comparable to a yolk used with conveyances pulled by animals, but now allows connection to a small motorized cart, a backpack assembly for manual pulling, and any other desired means. The power source is not claimed as part of the present invention but one of the objects of the invention is to facilitate its use with a variety of power sources. At the apex (13) of the pulling assembly triangle (10) is designated the point of connection (14) with the power source (not depicted in FIG. 1). This point of connection (14) could be any manner of connections, such as a trailer hitch, a handle, or a simple eyelet reinforced so that it would be capable of sustaining the force necessary to pull a load of waste material by dragging across the ground.

FIG. 1 further depicts a forward shaft member (30). In the basic embodiment of the invention the only requirement of the forward shaft member (30) is that it be of sufficient strength and rigidity to provide stability to the sled member (50) as well as to transmit the pulling force to the sled member (50).

Finally depicted in FIG. 1 is the sled member (50). The sled member (50) will be a flexible and coherent sheet like surface, such as a tarpaulin. The sled member (50) will be adapted so that it will substantially rest flat upon the ground so as to permit waste material to be easily raked, dragged or thrown upon its surface. While no dimensions have been specified, it is clear that the sled member surface (51) should be of sufficient size to allow piles of grass clippings, leaves, small shrubbery clippings, weeds, potting soil, small rocks, or other small items of waste to be placed within its outer edges with sufficient space to allow some degree of spreading or settling of the waste material without leaving the sled member surface (51).

It can also be seen on FIG. 1 that the sled member surface (51) is adapted near its periphery (56) on three sides (52, 53, 54) with a series of eyelets (55) which can be used for threading a flexible line (57) which could give the sled member (50) additional stability, additional resistance to the pulling force brought on by a heavy load, or for other applications as will be set forth below. Additionally, the sled member is adapted with a variety of accessories and features to accommodate various straps and settings as will be described more completely herein in order to permit the tarpaulin sled to be adapted to various specific tasks. Moreover, the sled member may also be made in various sizes to provide additional capabilities. These will be described in more detail below.

While no material need be specified, it is also clear that the sled member (50) will need to be made of a material which is strong enough to accept the desired amount of waste material as described above and also comprises a dragging surface (52) which will maintain its integrity as it is dragged over dirt, grass, small pebbles, sidewalks, driveway asphalt or surfaces, or other hazards upon which the waste material may be dragged in the course of movement from their creation to a waste collection or disposal point.

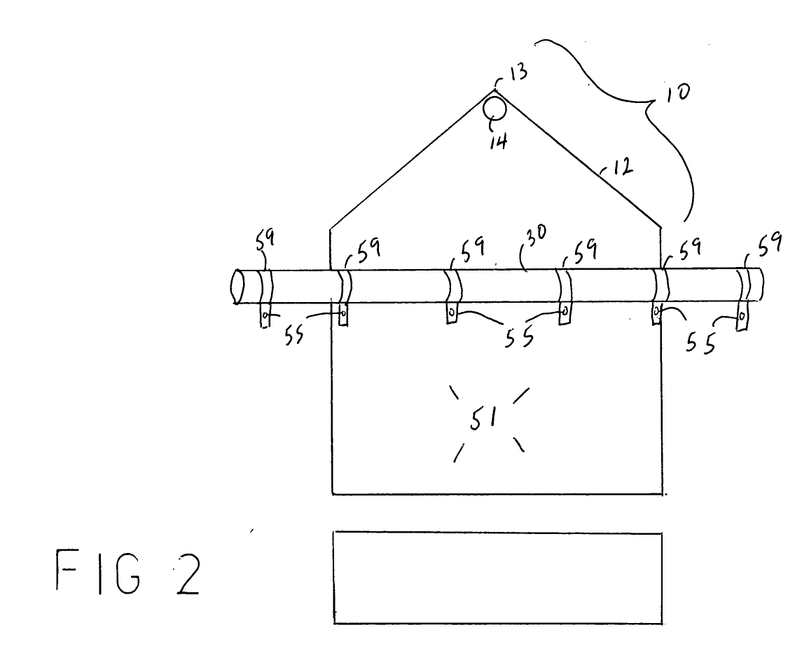

FIG. 2 depicts the basic apparatus which is enhanced to provide additional strength to the connection between the pulling member (10) and the forward shaft member (30). It can be seen that the forward edge (58) of the tarpaulin used for the dragging surface (52) is adapted with a series of straps (59) which are wrapped around the forward shaft member (30) and then fastened to the dragging surface (52) in any desired manner. Additionally, the forward edge (58) of the dragging surface (52) is further reinforced with one or more layers of an additional material (60) to reinforce the juncture (36) between the forward shaft member (30) and the dragging surface (52).

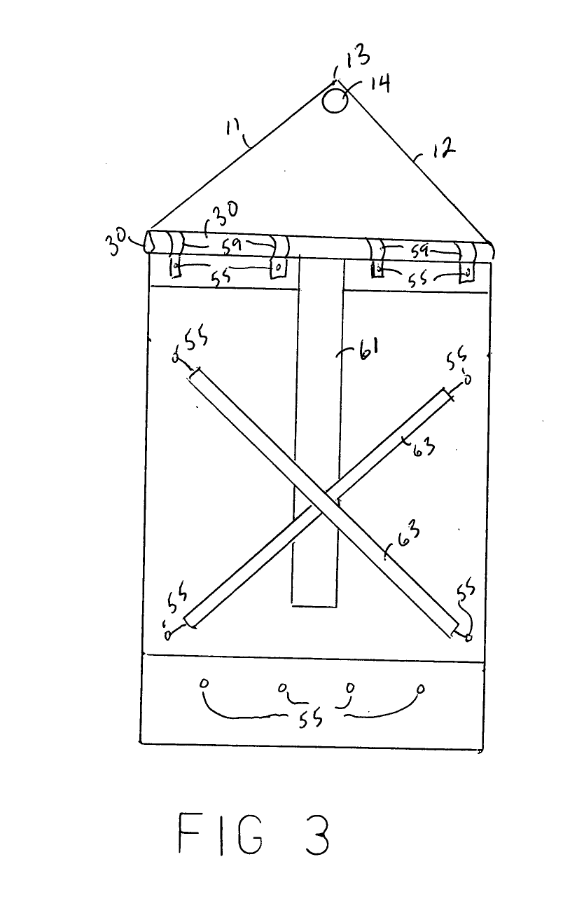

Making reference now to FIG. 3 it can be seen that an additional layer of material (61) can be placed lengthways down the center of the dragging surface (52) in order to provide additional strength. Also depicted in FIG. 3 it can be seen that any one or combination of a variety of flexible lines (63) (such as straps, ropes, cords, or other implements may be fastened to eyelets (55) in order to secure a load upon the dragging surface (52).

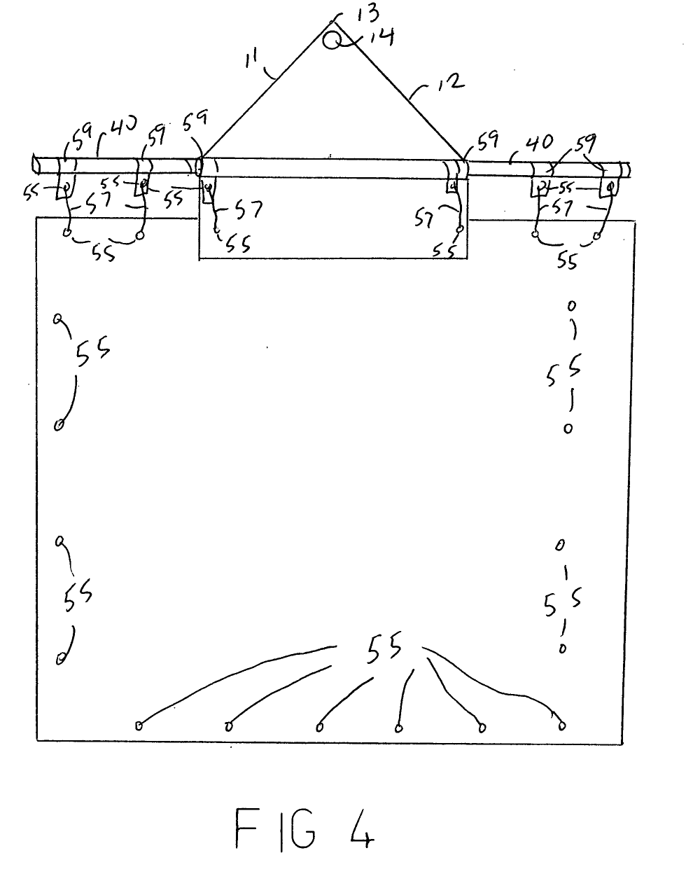

Making reference now to FIG. 4 it can be seen that the forward shaft member (30) has been reinforced by an interior shaft (40) which runs through the hollowed portion (41) of the forward shaft member (30) and extends out from either end (43, 44) and upon which additional connecting straps (45, 46) for attaching to a dragging surface (52) could be placed. Such additional strengthening shaft is useful when heavier loads are placed upon the tarpaulin. Such may also facilitate more efficient dragging of the tarpaulin sled since the leading edge will maintain its shape and the load will stay more reliably spread about the breadth of the tarpaulin. This distributes the frictional drag resistance between the bottom of the tarpaulin and the surface over which the tarpaulin sled is a being pulled.

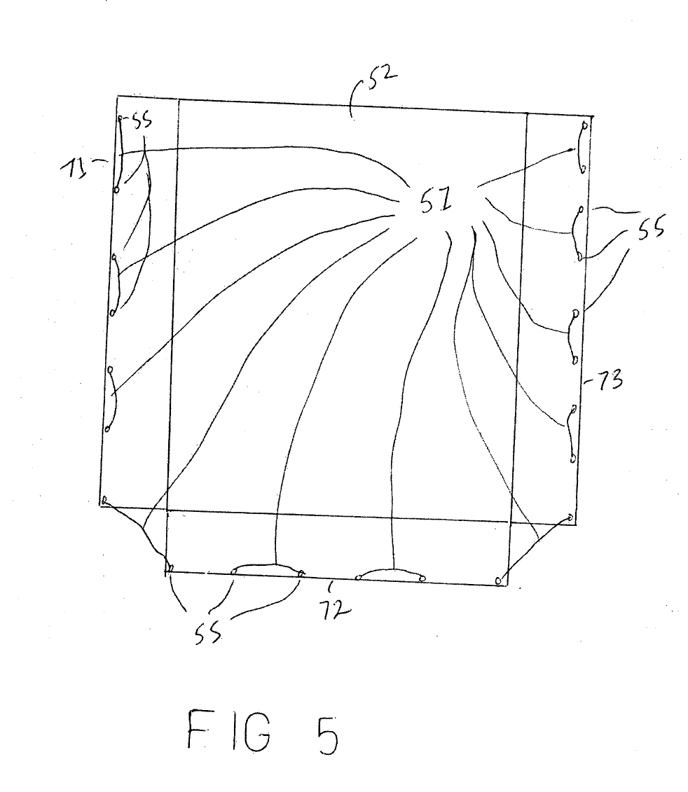

Making reference now to FIG. 5 it can be seen that the tarpaulin sled may also be adapted with side members. The side members are essentially extensions beyond the actual load bearing surface of the tarpaulin and extend out to either side or the back of the tarpaulin sled. By adapting these with eye lets or other fastening members about the periphery of the extension members they can be fastened across the tarpaulin sled so as to raise the extensions and generally form them into side members. Such side members would be very useful in preventing spillage of a target waste material, such as leaves, grass clippings, small twigs, or similar material which might otherwise tend to slide off of the tarpaulin sled either because of a breeze or from the motion of the sled as it is moved across a surface. In this manner the tarpaulin sled can be easily loaded with the “side” members resting on the ground by simply raking leaves or grass clippings onto the surface of the sled. Then besides can be raised for dragging so as to securely hold the waste material upon the sled as it is moved over some substantial distance at speeds associated with riding lawn mowers or other small tractors or recreational devices.

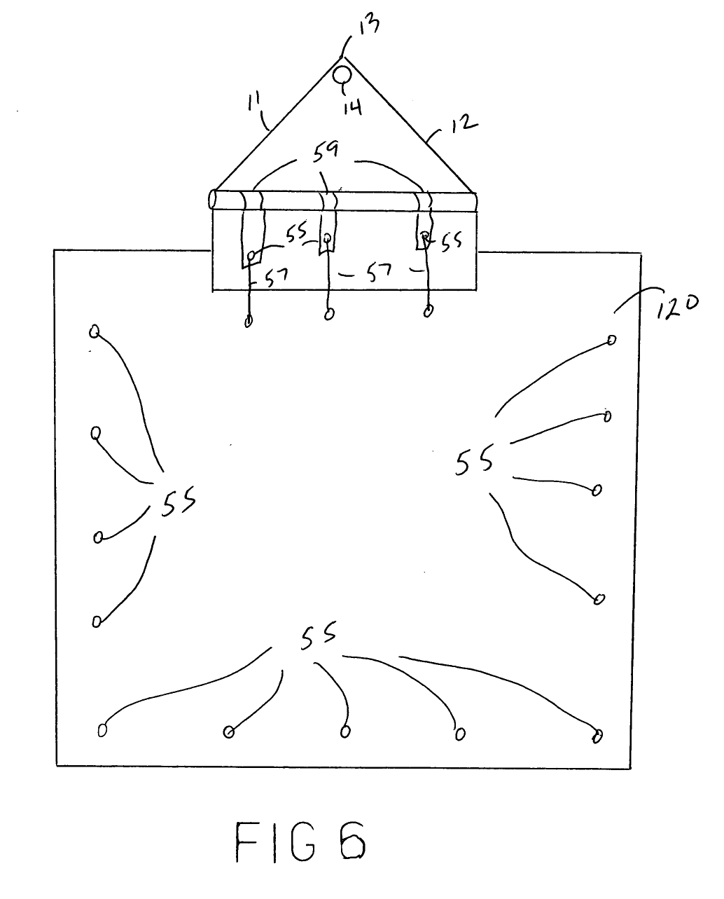

FIG. 6 depicts how the principles of the present invention could be practiced while increasing the size of the tarpaulin surface (120) in order to accommodate larger loads. It could be envisioned that one might have one size of tarpaulin for standard operations and perhaps another, larger tarpaulin for such applications as a very large pile of Fall leaves or grass clippings, such material being generally lightweight and amenable to pulling in larger quantities.

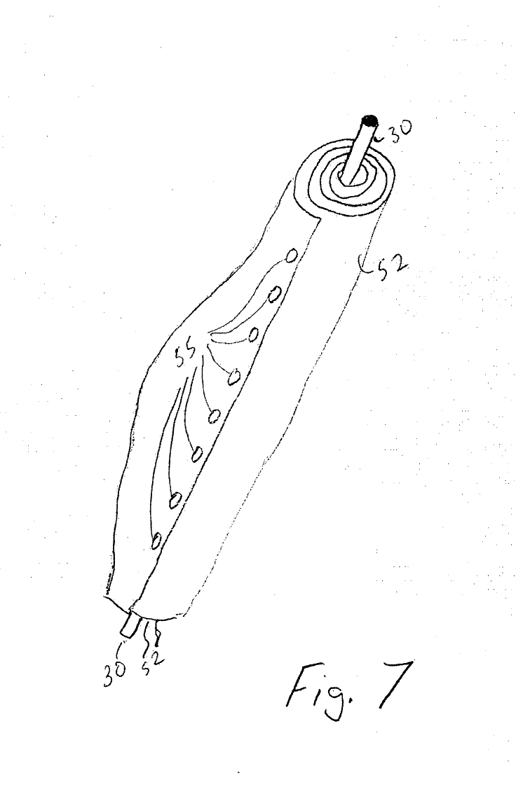

FIG. 7 depicts how the apparatus may be easily wrapped up for storage. It may be necessary to first clean the apparatus but its shape facilitates cleaning by simply sweeping off both sides of the tarpaulin and, if necessary and with use of the proper materials, hosing it off and letting it dry. The apparatus could be easily leaned in a corner of a garage, storage shed, or other desired location.

While the tarpaulin material has not been significantly discussed it should be clear that a variety of materials may be suitable for such a device and that each would offer its own set of advantages and disadvantages. The cost of manufacture of such an apparatus might be reduced by utilization of a cloth or synthetic material similar to cloth. Such material would be lightweight, inexpensive, could be laundered, and would be very easy to roll up for storage. A disadvantage of such material, however, would be that it would of the warm moisture and be subject to dry rot and may also be more subject to tearing or ripping when dragged over irregular or more rigid areas, such as sand, asphalt, ground with protruding rocks or stones, or other similar ground surfaces.

More rigid cloth materials, such as canvas, would overcome much of the threat to structural integrity posed by irregular ground services but would be harder to clean, heavier, and more difficult to work with.

There are a variety of synthetic plastic materials which could be adapted to this purpose. Without naming each of these forms of polymers it is well within common knowledge of such materials that they would be more difficult to roll up and store since they would be somewhat more rigid and the manufacture of a sled with such a polymer would be complicated by the addition of accessories as described above sense, generally speaking, adding such accessories to plastic materials is more difficult than simply soling them on board tying them in some way. They will normally require machine operations utilizing heat or more complicated joining operations.

One very good alternative would be a metallic foil. In this case it is likely that various layers of foil material would be adapted either with or without a filler material which could be anything from a layer of cloth to some granular or particulate matter. Such a foil come posit structure would offer advantages of strength, non-porosity, ready accessibility for accessories, easy roll-up for storage, reasonably light weight, and could be cleaned by simply hosing them off. It is also likely that manufacture of the apparatus with a metallic foil as opposed to the other materials might be more costly but would also offer the advantages of durability and ease of use.

The features of the invention may be practiced equally with any of these materials and these materials are mentioned only as a means of demonstrating the versatility of the apparatus and not for the purpose of limiting its application to any particular material. Accordingly, it is expressly intended that the components above and their various combinations can be and should be made of any desirable material, whether one which has been specifically mentioned or one which has not been mentioned or one which is still under development.

The use of eyelets has been mentioned as means of channeling various lines and straps for the purpose of achieving such objectives as employing the side members, strapping down loads, or facilitating the junction between the pulling energy and the tarpaulin. While eyelets are easy to depict and describe and clearly serve the purposes of the invention, it should also be mentioned that the same functions of channeling lines and straps for raising the sides or fastening and securing loads to the load bearing surface could be achieved by other means, such as a looped member through which the line may pass or by permanently fastening lines to the tarpaulin sled service at desired positions or even by adapting the apparatus with elongated channels through which a line or strapped may be permanently or removably inserted.

It should also be noted that the various means of securing or holding the target load upon the tarpaulin surface may also be varied and combined in any desired combination. For instance, netting could be provided capable of closing over the load and then secured by straps which either were positioned to crisscross the tarpaulin surface or to cross its length or breadth in a straight line. Either or both of these could be used at the same time. Moreover, either or both of these means of securing a load could be used upon either a tarpaulin surface with raised sides or an enlarged tarpaulin surface. Any of these combinations would be in keeping within the spirit and scope of the present invention.

It is also pointed out that, while the use of eyelets has been taught as a simple means of fastening accessories and running lines as required to either secure the load or connect with a power source, accessories could be applied to the tarpaulin surface by means of permanent sewing, matching Velcro® surfaces, zippers, snaps and latches, or any desired means of connection with sufficient strength for the task. Accordingly, no particular means of connection is either taught more required in the practice of the preferred embodiments of the present invention and all such means should be seen as keeping within the spirit and scope of the claims of the present invention.

Further modification and variation can be made to the disclosed embodiments without departing from the subject and spirit of the invention as defined in the following claims. All such modifications and variations, as included within the scope of these claims, are meant to be considered part of the invention as described.

What is claimed is:

1. Apparatus for moving a variety of material associated with landscaping, horticulture, or care and cleaning of a lawn or field, the apparatus comprising:
a tarpaulin load bearing surface adequate for the placement of a variety of materials associated with landscaping, or to culture, care or cleaning of a lawn or field, or similar outdoor activities, said tarpaulin load bearing surface being of adequate strength and size to permit such materials to be placed upon said tarpaulin load bearing surface and dragged across a lawn or field of grass, sand, or gravel;
a connecting shaft for said tarpaulin load bearing surface, said connecting shaft being adapted to offer connection and support across a leading edge of said tarpaulin load bearing surface so that said shaft will maintain the leading edge of said tarpaulin load bearing surface in a substantially straight-line and a direction substantially perpendicular to a desired path of movement of said tarpaulin load bearing surface;
said connecting shaft being further in physical communication with a harness member, said harness member being further adapted to join said connecting shaft with a source of pulling power so that said source of pulling power can be applied across the length of said connecting shaft and, consequently, across the breadth of said tarpaulin load bearing surface leading edge in order to poll said tarpaulin load bearing surface across a lawn or field of grass, sand, or gravel.

2. Apparatus for moving a variety of material associated with landscaping, horticulture, or care and cleaning of a lawn or field, as described in claim 1, in which said tarpaulin load bearing surface is further adapted with one or more straps which are positioned and are of adequate length to cross said tarpaulin load bearing surface and secure material or debris which may be positioned upon said tarpaulin load bearing surface.

3. Apparatus for moving a variety of material associated with landscaping, horticulture, or care and cleaning of a lawn or field, as described in claim 1, in which said tarpaulin load bearing surface is further adapted with two side members and one rear member, each said side member being generally rectangular so that its long rectangle sides are joined along opposite sides of said tarpaulin load bearing surface and that its rear member is generally rectangular so that its long rectangular side is joined along the rear edge of said load bearing surface, said side members and said rear member being further adapted along their free long rectangle or sides with means for drawling each said side member and rear member into said tarpaulin load bearing surface in a manner so as to create an enclosure within said tarpaulin load bearing surface and to hold loose or light material upon said tarpaulin load bearing surface during the course of movement or in response to a gentle breeze or wind.

4. Apparatus for moving a variety of material associated with landscaping, horticulture, or care and cleaning of a lawn or field as described in claim 1 in which said connecting shaft is fastened to said tarpaulin load bearing surface leading edge by means of a series of eyelets across said tarpaulin load bearing surface leading edge which are fastened to said connecting shaft by means of flexible lines which are passed through each said eyelet and fastened to said connecting shaft through a series of line receiving loop members which are positioned in a line along said connecting shaft so as to correspond with the series of eyelets across said tarpaulin load bearing surface.

5. Apparatus for moving a variety of material associated with landscaping, horticulture, or care and cleaning of a lawn or field in which said connecting shaft is fastened to said tarpaulin load bearing surface leading edge by means of a receiving channel position along said tarpaulin load bearing surface which is adapted to receive said connecting shaft

6. Apparatus for moving a variety of material associated with landscaping, horticulture, or care and cleaning of a lawn or field as described in claim four in which said harness member further comprises a series of looped members which are positioned in a line across the length of said connecting shaft and from which each said looped member receives a flexible line which is acid to said loop member and which converges upon a pulling member which is further adapted to join said harness with a pulling force.

7. Apparatus for moving a variety of material associated with landscaping, horticulture, or care and cleaning of a lawn or field as described in claim five in which said harness member or other comprises a flexible line which is connected to said connecting shaft at each end of said connecting shaft which may protrude from said tarpaulin load bearing surface leading edge receiving channel and, at or near the center of said line, is connected to a pulling member which is further adapted to join said harness with a pulling force.

8. Apparatus for moving a variety of material associated with landscaping, horticulture, or care and cleaning of a lawn or field, the apparatus comprising:
a tarpaulin load bearing surface adequate for the placement of a variety of materials associated with landscaping, or to culture, care or cleaning of a lawn or field, or similar outdoor activities, said tarpaulin load bearing surface being of adequate strength and size to permit such materials to be placed upon said tarpaulin load bearing surface and dragged across a lawn or field of grass, sand, or gravel;
said tarpaulin load bearing surface is further adapted with two side members and one rear member, each said side member being generally rectangular so that its long rectangle sides are joined along opposite sides of said tarpaulin load bearing surface and that its rear member is generally rectangular so that its long rectangular side is joined along the rear edge of said load bearing surface, said side members and said rear member being further adapted along their free long rectangle or sides with means for drawling each said side member and rear member into said tarpaulin load bearing surface in a manner so as to create an enclosure within said tarpaulin load bearing surface and to hold loose or light material upon said tarpaulin load bearing surface during the course of movement or in response to a gentle breeze or wind;
a connecting shaft for said tarpaulin load bearing surface, said connecting shaft being adapted to offer connection and support across a leading edge of said tarpaulin load bearing surface so that said shaft will maintain the leading edge of said tarpaulin load bearing surface in a substantially straight-line and a direction substantially perpendicular to a desired path of movement of said tarpaulin load bearing surface;
said connecting shaft being further in physical communication with a harness member, said harness member being further adapted to join said connecting shaft with a source of pulling power so that said source of pulling power can be applied across the length of said connecting shaft and, consequently, across the breadth of said tarpaulin load bearing surface leading edge in order to poll said tarpaulin load bearing surface across a lawn or field of grass, sand, or gravel.

9. Apparatus for moving a variety of material associated with landscaping, horticulture, or care and cleaning of a lawn or field as described in claim 8 in which said connecting shaft is fastened to said tarpaulin load bearing surface leading edge by means of a series of eyelets across said tarpaulin load bearing surface leading edge which are fastened to said connecting shaft by means of flexible lines which are passed through each said eyelet and fastened to said connecting shaft through a series of line receiving loop members which are positioned in a line along said connecting shaft so as to correspond with the series of eyelets across said tarpaulin load bearing surface.

10. Apparatus for moving a variety of material associated with landscaping, which are positioned and are of adequate length to cross said tarpaulin load bearing surface and secure material or debris which may be positioned upon said tarpaulin load bearing surface and which may further be, optionally, adapted with netting material which may be placed over a target load and secured by said straps;
a connecting shaft for said tarpaulin load bearing surface, said connecting shaft being adapted to offer connection and support across a leading edge of said tarpaulin load bearing surface so that said shaft will maintain the leading edge of said tarpaulin load bearing surface in a substantially straight-line and a direction substantially perpendicular to a desired path of movement of said tarpaulin load bearing surface;
said connecting shaft being further in physical communication with a harness member, said harness member being further adapted to join said connecting shaft with a source of pulling power so that said source of pulling power can be applied across the length of said connecting shaft and, consequently, across the breadth of said tarpaulin load bearing surface leading edge in order to poll said tarpaulin load bearing surface across a lawn or field of grass, sand, or gravel.

14. Apparatus for moving a variety of material associated with landscaping, horticulture, or care and cleaning of a lawn or field as described in claim 13 in which said connecting shaft is fastened to said tarpaulin load bearing surface leading edge by means of a series of eyelets across said tarpaulin load bearing surface leading edge which are fastened to said connecting shaft by means of flexible lines which are passed through each said eyelet and fastened to said connecting shaft through a series of line receiving loop members which are positioned in a line along said connecting shaft so as to correspond with the series of eyelets across said tarpaulin load bearing surface.

15. Apparatus for moving a variety of material associated with landscaping, horticulture, or care and cleaning of a lawn or field as described in claim 13 in which said connecting shaft is fastened to said tarpaulin load bearing surface leading edge by means of a receiving channel position along said tarpaulin load bearing surface which is adapted to receive said connecting shaft.

16. Apparatus for moving a variety of material associated with landscaping, horticulture, or care and cleaning of a lawn or field as described in claim 15 in which said harness member further comprises a series of looped members which are positioned in a line across the length of said connecting shaft and from which each said looped member receives a flexible line which is acid to said loop member and which converges upon a pulling member which is further adapted to join said harness with a pulling force.

17. Apparatus for moving a variety of material associated with landscaping, horticulture, or care and cleaning of a lawn or field as described in claim 16 in which said harness member or other comprises a flexible line which is connected to said connecting shaft at each end of said connecting shaft which may protrude from said tarpaulin load bearing surface leading edge receiving channel and, at or near the center of said line, is connected to a pulling member which is further adapted to join said harness with a pulling force.
